(19) United States
(12) Patent Application Publication
(10) Pub. No.: US 2026/0364688 A1
(43) Pub. Date: Nov. 19, 2026

(54) CUTTING TOOL

(71) Applicant: Element Six (UK) Limited, Oxfordshire (GB)

(72) Inventors: Luiz Fernando PENNA FRANCA, Oxfordshire (GB); Carmen Elena ZVORISTE-WALTERS, Oxfordshire (GB)

(73) Assignee: Element Six (UK) Limited, Oxfordshire (GB)

(21) Appl. No.: 19/132,370

(22) PCT Filed: Jan. 29, 2024
(86) PCT No.: PCT/EP2024/052047

§ 371 Date: May 23, 2025

(30) Foreign Application Priority Data
Jan. 30, 2023 (GB) 2301305.5

(51) Int. Cl. B23C 5/10; B23P 15/34

(52) U.S. Cl. CPC B23C 5/10; B23P 15/34; B23C 2226/315

(57) ABSTRACT

Herein is disclosed a cutting tool comprising: a tool shank having an axis of rotation, and further comprising a tool head at one end thereof, the tool head comprising a tier, wherein the tier of the tool head comprises a cutting surface formed of polycrystalline CVD diamond and wherein the cutting surface comprises a plurality of satellites, wherein a sharpness ratio β of the cutting tool is in the range from about 0.01 to about 1.5, and wherein the sharpness ratio β is the ratio of the average height H (mm) of the satellites to the average overlapping length L (mm) between two adjacent satellites, a method of making the above-mentioned tool head, and a use of the cutting tool in a method of cutting a brittle material.

### FIELD OF THE INVENTION

This disclosure relates to a cutting tool. In particular, it relates to a cutting tool for cutting brittle materials, such as glass. More particularly, it relates to a cutting tool comprising a cutting surface formed of polycrystalline CVD diamond, wherein the cutting surface comprises a plurality of satellites (i.e. protrusions) which act as cutting elements.

### BACKGROUND

Micro end mill cutters are deployed in milling operations during the construction of, for example, mobile phone handset shells. Handset shells are typically made from aluminium, polycarbonate, glass or ceramics. One of the incumbent technologies is diamond electroplated micro end mill cutters. In electroplated cutters, hundreds of individual diamond grits are embedded into a bonding agent on the surface of the tool head to provide numerous cutting surfaces and edges. However, a problem with electroplated milling tools is that the diamond grits are prone to pull-outs from the bonding agent, rendering the workpiece vulnerable to unwanted scratches from the rogue grits. Another problem is that diamond electroplated tools have a limited tool life, necessitating regular tooling changes and increasing the cost of production with every tool required. As an alternative, PCD end milling tools can be used. However, such tools require flutes to provide a defined cutting surface and machining the tool head to form the required flutes is an additional processing step.

It is an object of the invention to address the above issues of incumbent tools, such as grit pull-outs, tool life, and the requirement to form flutes, thereby providing an improved cutting tool.

### SUMMARY OF THE INVENTION

According to a first aspect, there is provided a cutting tool comprising: a tool shank having an axis of rotation, and further comprising a tool head at one end thereof, the tool head comprising a tier, wherein the tier of the tool head comprises a cutting surface formed of polycrystalline CVD diamond and wherein the cutting surface comprises a plurality of satellites (i.e. protrusions), wherein a sharpness ratio β of the cutting tool is in the range from about 0.01 to about 1.5, wherein the sharpness ratio β is the ratio of the average height H (mm) of the satellites (i.e. protrusions) to the average overlapping length L (mm) between two adjacent satellites (i.e. protrusions).

β=H/L EQUATION 1

In the present disclosure, the term “satellite” and the term “protrusion” are considered to be entirely interchangeable and synonymous. By “satellite” is meant a body which protrudes from and is integrally formed with the polycrystalline CVD diamond cutting surface as described herein, in other words, a protrusion. The satellites function as cutting elements.

As an option, the sharpness ratio β of the cutting tool is in the range from about 0.01 to about 0.5, optionally from about 0.01 to about 1.

As an option, the average height H (mm) of the satellites (i.e. protrusions) is from about 0.005 mm to about 0.025 mm.

As an option, the average overlapping length L (mm) between two adjacent satellites (i.e. protrusions) is from about 0.02 mm to about 1 mm.

As an option, the satellites (i.e. protrusions) have an average diameter D of from about 0.005 mm to about 0.025 mm.

As an option, the area density C of the satellites (i.e. protrusions) is from about 50 per mm² to about 1000 per mm².

As an option, CD≥1 (i.e. C multiplied by D is greater than or equal to 1), wherein C is the area density (per mm²) of the satellites (i.e. protrusions) and D is the average diameter (mm) of the satellites (i.e. protrusions).

As an option, the satellites (i.e. protrusions) are continuously curved.

As an option, the tool head comprises at least one further tier, wherein the tiers are axially displaced from each other and separated by a non-cutting portion of the tool head.

As an option, at least one of the at least one further tiers comprises a cutting surface formed of polycrystalline CVD diamond, wherein the cutting surface is as defined herein.

As an option, each tier comprises a cutting surface formed of polycrystalline CVD diamond, wherein the cutting surface is as defined herein.

As an option, the tool comprises at least two tiers.

As an option, the tool comprises at least three tiers.

As an option, at least one tier is configured for operations selected from any of roughing, semi-finishing, and finishing.

As an option, two or more tiers are configured for the same operation, e.g. roughing, semi-finishing, finishing.

As an option, each tier is configured differently to the remaining tiers.

As an option, at least one tier has a different diameter to the other tiers.

As an option, the tool head is cylindrical and non-tubular.

As an option, the tool head has an overall height of no more than 12 mm.

As an option, the tool head has an overall height of no less than 0.5 mm.

As an option, the tool shank has an outer diameter selected from any of no more than 15 mm, no more than 10 mm and no less than 6 mm.

As an option, the tool shank and/or the tool head comprises cemented carbide.

As an option, at least one tier of the tool head comprises cemented carbide.

The material to be cut optionally comprises any of glass, ceramic, polymer, composites, metallic materials and metal-ceramic composites.

The tool shank optionally further comprises a conduit for carrying compressed air to the tool head to eject waste cutting media.

According to a second aspect, there is provided a method of making a cutting tool head, the method comprising the steps of:
a. providing a disc blank;
b. machining at least one precursor tool head from the disc;
c. forming a tier in the precursor tool head to thereby form a tool head comprising a tier; and
d. depositing polycrystalline diamond on the tier of the tool head using chemical vapour deposition to form a cutting surface of polycrystalline CVD diamond on the tier, wherein the cutting surface comprises a plurality of satellites (i.e. protrusions), wherein a sharpness ratio ß of the cutting tool is in the range from 0.01 to 1.5, wherein the sharpness ratio @ is the ratio of the average height H (mm) of the satellites (i.e. protrusions) to the average overlapping length L (mm) between two adjacent satellites (i.e. protrusions).

As an option, the tier is formed in the precursor tool head using a laser.

As an option, the method further comprises repeating step c as required, to thereby form a tool head comprising at least two tiers, each tier comprising a cutting surface formed of polycrystalline CVD diamond, wherein the cutting surface comprises a plurality of satellites (i.e. protrusions), wherein the tiers are axially displaced from each other and separated by a non-cutting portion of the tool head.

As an option, the method further comprises repeating step c as required, to thereby form a tool head comprising a plurality of tiers.

As an option, the method further comprises repeating steps c and d as required, to thereby form a tool head comprising at least two tiers, each tier comprising a cutting surface formed of polycrystalline CVD diamond, wherein the cutting surface comprises a plurality of satellites (i.e. protrusions), wherein the tiers are axially displaced from each other and separated by a non-cutting portion of the tool head.

As an option, the method further comprises repeating steps c and d as required, to thereby form a tool head comprising at least two tiers, wherein at least one tier comprises a cutting surface formed of polycrystalline CVD diamond, wherein the cutting surface comprises a plurality of satellites (i.e. protrusions), wherein the tiers are axially displaced from each other and separated by a non-cutting portion of the tool head.

As an option, the method further comprises repeating step c as required, to thereby form a tool head comprising a plurality of tiers, wherein at least two of the plurality of tiers comprise a cutting surface formed of polycrystalline CVD diamond, wherein the cutting surface comprises a plurality of satellites (i.e. protrusions), wherein the tiers are axially displaced from each other and separated by a non-cutting portion of the tool head.

As an option, the chemical vapour deposition of polycrystalline diamond comprises hot filament chemical vapour deposition.

According to a third aspect, there is provided a use of the cutting tool as described herein in a method of cutting, for example grinding, a brittle material, for example any of glass, ceramic, polymer, composites, metallic materials and metal-ceramic composites.

### BRIEF DESCIPTION OF THE DRAWINGS

The invention will now be more particularly described, by way of example only, with reference to the accompanying drawings, in which:

FIG. 1 is a perspective view of a tool in accordance with the invention, with a first embodiment of a tool head;

FIG. 2 is a front view of the tool of FIG. 1;

FIG. 3 is an enlarged view of portion X from FIG. 2;

FIG. 4 is a schematic profile view of the CVD diamond cutting surface which shows how the height H of the protrusions is determined;

FIG. 5 is a schematic plan view of the CVD diamond cutting surface which shows how the overlapping length L (mm) between two adjacent satellites (i.e. protrusions) is determined;

FIG. 6 is a schematic plan view of the CVD diamond cutting surface which shows how the area density C of the satellites (i.e. protrusions) is determined;

FIG. 7 is an enlarged view of portion Y from FIG. 6 and shows how the diameter D of the satellites (i.e. protrusions) is determined;

FIG. 8 is a front view of a second embodiment of a tool head;

FIG. 9 is a front view of a third embodiment of a tool head;

FIG. 10 is a front view of a fourth embodiment of a tool head;

FIG. 11 is an annotated version of the tool head of FIG. 9.

Throughout the embodiments, similar parts are denoted by the same reference numeral and a further description is omitted for brevity.

### DETAILED DESCRIPTION

The following description refers to cutting glass by way of example, but it will be appreciated that the same tool configuration can be used for cutting, for example grinding, other types of material, for example, other types of brittle material. A non-limiting list of materials that can be cut includes glass, ceramic, polymer, composites, metallic materials and metal-ceramic composites.

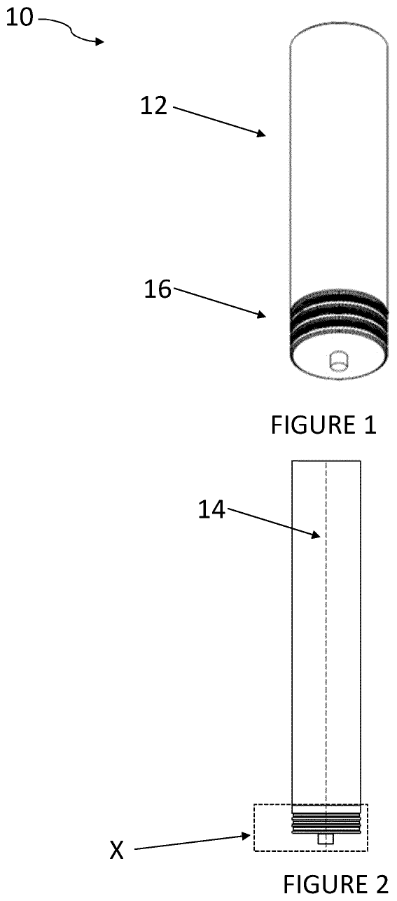

Referring firstly to FIGS. 1 to 3, a cutting tool is indicated generally at 10. The tool comprises a tool shank 12 having a longitudinal axis of rotation 14, and further comprises a tool head 16 at one end of the shank 12. The tool head 16 comprises at least one tier 18 (i.e. a stage or a level). Additional tiers are axially displaced with regards to the initial tier. A tool with multiple tiers therefore has tiers that are co-axially aligned and adjacent to each other.

The cutting surface of the tool head 16 is formed of chemical vapour deposition (CVD) polycrystalline diamond (PCD). The cutting surface comprises a plurality of satellites (i.e. protrusions). These satellites (i.e. protrusions) emanate from and are integral with the CVD polycrystalline diamond cutting surface. The satellites (i.e. protrusions) are formed of CVD polycrystalline diamond. The satellites (i.e. protrusions) fulfil a similar function to the diamond grits which are embedded in the conventional diamond electroplated tools described above, i.e. they act as cutting elements. As the satellites (i.e. protrusions) are part of the CVD diamond coating, they are not prone to pull-outs from a bonding agent. In addition, these satellites (i.e. protrusions) eliminate the requirement for flutes to be machined on the tool head, as they function as cutting elements, eliminating a processing step in the manufacturing of the tool head as compared to conventional PCD tools described above. The cutting tool disclosed herein is therefore an improvement compared to conventional end mill cutters.

The tool head serves as a substrate for the polycrystalline CVD diamond coating. The tool head can therefore be formed of or comprise any suitable substrate for CVD coating of polycrystalline diamond. For example, the tool head may be formed of or comprise metal carbides, such as tungsten carbide, silicon carbide, and/or silicon nitride.

The number average height H of the satellites (i.e. protrusions) may be from about 0.005 mm to about 0.025 mm, optionally from about 0.010 mm to about 0.020 mm, optionally from about 0.015 mm to about 0.020 mm. The number average height H of the satellites (i.e. protrusions) is measured according to methods known to the person skilled in the art, for example, using scanning electron microscopy (SEM). An example method is as follows: an SEM image is taken perpendicular to the cutting surface such that the full profile of the satellites (i.e. protrusions) is visible. The distance from the base to the tip of a satellite (i.e. protrusion) is then measured in a direction perpendicular to the cutting surface, as depicted schematically in FIG. 4. This process is performed for at least 100 satellites (i.e. protrusions) to obtain a number average, i.e. a mean, height H of the satellites (i.e. protrusions).

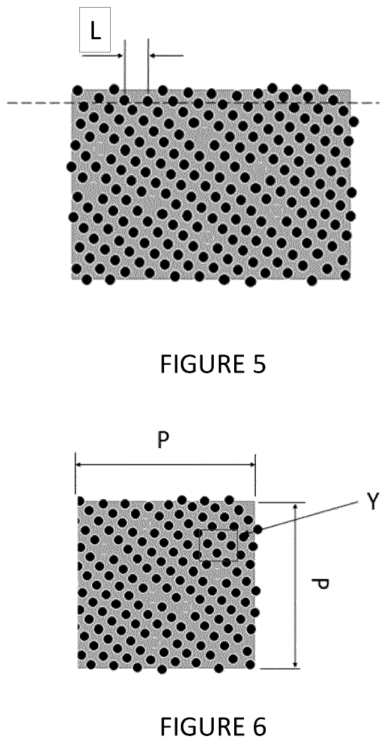

The average overlapping length L between two adjacent satellites (i.e. protrusions) may be from about 0.02 mm to about 1 mm, optionally from about 0.05 mm to about 1 mm, optionally from about 0.1 mm to about 1 mm, optionally from about 0.1 mm to about 0.75 mm, optionally from about 0.2 mm to about 0.5 mm. The average overlapping length L between two adjacent satellites (i.e. protrusions) is measured according to methods known to the person skilled in the art, for example, using SEM. An example method is as follows: an SEM image is taken perpendicular to the cutting surface such that the satellites (i.e. protrusions) are visible from above, i.e. to provide a plan view of the cutting surface as depicted in the schematic in FIG. 5. The distance from the centre of one satellite (i.e. protrusion) to the centre of an adjacent satellite (i.e. protrusion) is then measured as a straight line, as depicted schematically in FIG. 5. This process is then repeated for each satellite (i.e. protrusion) in the image, at least 100 satellites (i.e. protrusions), to obtain a number average, i.e. a mean, overlapping length L between two adjacent satellites (i.e. protrusions).

The sharpness ratio β of the cutting tool is calculated by taking the ratio of the average height H of the satellites (i.e. protrusions) to the average overlapping length L between two adjacent satellites (i.e. protrusions). The desired sharpness ratio β depends on the type of material to be cut. For efficient cutting of brittle materials, such as glass, it has been found that the sharpness ratio β should be in the range of from about 0.01 to about 1.5, optionally from about 0.01 to about 1.25, optionally from about 0.01 to about 1, optionally from about 0.01 to about 0.75, optionally from about 0.01 to about 0.5, optionally from about 0.05 to about 0.25, optionally from about 0.10 to about 0.25, optionally from about 0.15 to about 0.25.

The area density C of the satellites (i.e. protrusions) may be from about 50 per mm² to about 1000 per mm², optionally from about 100 per mm² to about 900 per mm², optionally from about 100 per mm² to about 800 per mm², optionally from about 200 per mm² to about 700 per mm², optionally from about 300 per mm² to about 600 per mm², optionally from about 400 per mm² to about 500 per mm². The area density C of the satellites (i.e. protrusions) can also be measured using methods known to the person skilled in the art, for example, using SEM. An example method is depicted schematically in FIG. 6. An SEM image of a plan view of the cutting surface is obtained, as in the measurement of the average overlapping length L between two adjacent satellites (i.e. protrusions). A square region (containing at least 100 satellites (i.e. protrusions)) with side lengths P is identified, as shown schematically in FIG. 6, and the number of satellites (i.e. protrusions) in or partially in the square region are counted. The area density C of the satellites (i.e. protrusions) is then calculated by dividing the number of satellites (i.e. protrusions) by the square side length P squared to obtain the number of satellites (i.e. protrusions) per unit area. In this disclosure, area density is expressed in units of per mm², i.e. mm⁻².

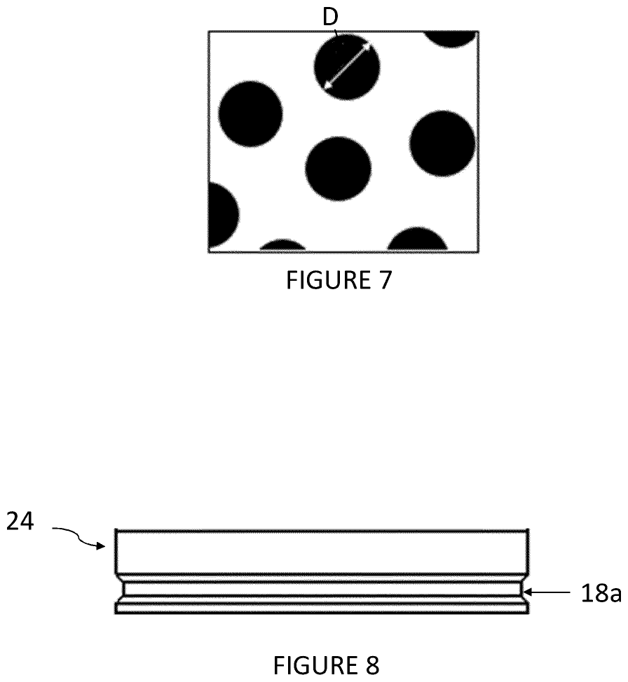

From the same SEM image, the average diameter D of the satellites (i.e. protrusions) can be measured. This is done by measuring each satellite (i.e. protrusion) in the square region along its longest axis, as depicted schematically in FIG. 7, summing the measured diameters for all the satellites (i.e. protrusions) and dividing by the total number of satellites (i.e. protrusions) in the square region. The average diameter D of the satellites (i.e. protrusions) can be from about 0.005 mm to about 0.025 mm, optionally from about 0.010 mm to about 0.020 mm, optionally from about 0.010 mm to about 0.015 mm.

Where the product of the area density C of the satellites (per mm²) (i.e. protrusions) and the average diameter D (mm) of the satellites (i.e. protrusions) is greater than or equal to one (i.e. CD≥1), the coating design is particularly suitable for cutting brittle materials. If the product of the area density C of the satellites (per mm²) (i.e. protrusions) and the average diameter D (mm) of the satellites (i.e. protrusions) is less than one, the coating design may not be appropriate for cutting brittle materials.

In certain embodiments, the satellites (i.e. protrusions) may be continuously curved. For example, the satellites (i.e. protrusions) may be substantially dome-shaped, or the satellites (i.e. protrusions) may be substantially elliptical, hemi-elliptical, spherical, hemispherical, ovoid, and/or hemiovoid.

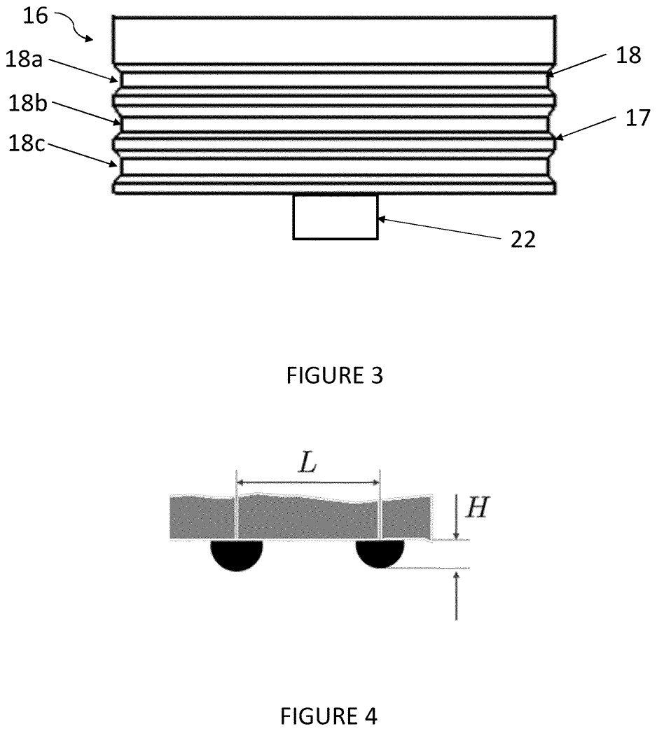

FIG. 3 shows a first embodiment of a tool head 16. Tool head 16 comprises three tiers 18a, 18b, 18c and a notch element 22. Tier 18a corresponds to the tier closest to the shank, tier 18c corresponds to the tier furthest away from the shank, and tier 18b corresponds to the tier axially intermediate tiers 18a and 18c. Each tier 18 is separated from an adjacent tier 18 by a non-cutting portion 17 of the tool head 16.

The notch element 22 is configured to carve a correspondingly shaped notch into a workpiece, for example a microphone aperture in a mobile phone handset shell. As an example only, the notch element 22 may have a diameter of up to 1 mm and a height of up to 1 mm. The notch element 22 is entirely optional and may be omitted.

In FIG. 8, an exemplary tool head 24 is shown. In this example, only a single tier 18a is provided.

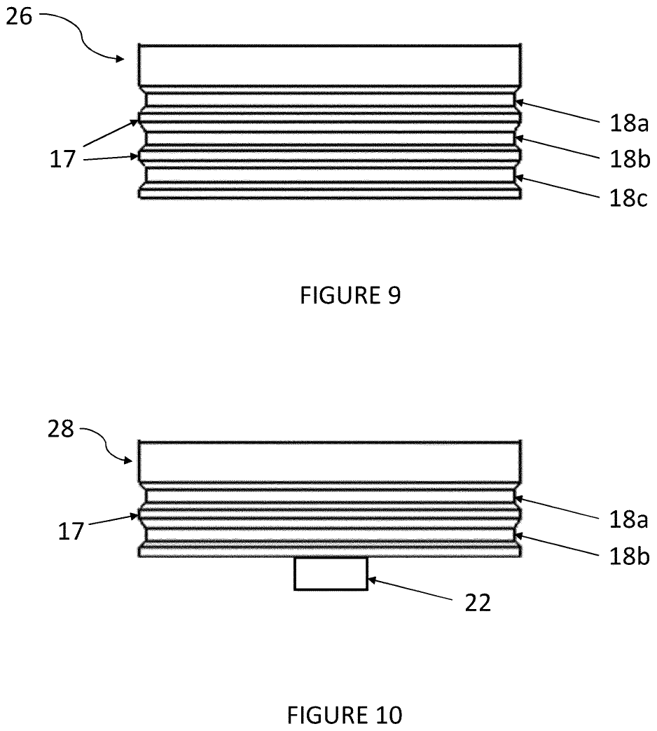

Turning now to FIG. 9, a further embodiment of a tool head 26 is shown. In this embodiment, three tiers 18a, 18b, 18c are again provided, each separated from the adjacent tiers by a non-cutting portion. Each of the three tiers 18a, 18b and 18c is configured for finishing operations. However, the three tiers may all be configured for roughing, or alternatively they may all be configured for semi-finishing. The advantage of the configuration where all tiers are configured for the same cutting (e.g. grinding) operation is that it extends the service life of the tool by a factor of ‘n’ where ‘n’ is the quantity of tiers. As the first tier, whichever one it might be that is used first, wears out, then the spindle can be extended or retracted as appropriate, to move one of the other tiers into position. This is repeated as and when required, depending on the quantity of tiers 18 provided. Since the wear rate is the same for all three tiers, the operational life of the tool is maximised.

In a further embodiment, three tiers 18a, 18b, 18c are again provided, each separated from the adjacent tiers by a non-cutting portion 17 as shown in FIG. 9. The first and second tiers 18a, 18b respectively, are configured for semi-finishing cutting operations. Only the third tier 18c is configured for finishing cutting operations. One of the advantages of this configuration is that, unlike the example given in the preceding paragraph, it does not require the additional tool change between cutting operations. The tool is multi-functional and can be used for more than one specific cutting operation, thereby reducing machine downtime and maximising operational equipment effectiveness. A tool configured for more than one type of cutting operation may be considered to be a ‘multi-tool’.

The inventors have found that the tier furthest away from the shank 12 experiences the greatest forces and greatest moments during use and therefore in principle would wear away at the greatest rate. With higher moments also comes less stability and higher vibrations. It is important to consider that the wear morphology for the different cutting operations varies too. For example, during finishing, wear tends to be abrasive wear exclusively, whereas during semi-finishing, chipping also occurs. These factors can all contribute towards premature failure of the tool. Therefore, it is important to consider the relative positioning of tiers 18 and their configuration for specific cutting operations.

It is preferable to situate the tier configured for finishing operations furthest away from the shank because finishing operations require less forces and produce less wear. By placing the two tiers configured for semi-finishing closer to the shank, the wear rate across the three tiers 18 is balanced out and the life of the three tiers 18 is maximised. Also, by having a greater quantity of tiers for semi-finishing and roughing, since the probability of failure from chipping is higher from these cutting operations, the tool provides operational redundancy and enables swift substitution with follow-on tiers, thereby minimising machine downtime.

Since a finishing operation produces half as much wear as a semi-finishing process, a tier configured for finishing will have a life that is approximately twice as long as a tier configured for semi-finishing. Having twice as many tiers for semi-finishing cutting operations as tiers for finishing operations is therefore an optimum proportion. As an example, for a tool with six tiers in total, four of those tiers would be for semi-finishing and two of those tiers would be for finishing. To continue the example, a tool with twelve tiers in total, eight of those tiers would be for semi-finishing and four of those tiers would be for finishing.

In another embodiment, not shown, the tiers 18 may all be configured exclusively for roughing operations. In another embodiment, not shown, not all of the tiers comprise a cutting surface formed of polycrystalline CVD diamond as disclosed herein. It is contemplated that different tiers of the tool may comprise different cutting surfaces which are adapted to, for example, cutting different materials or performing different operations, thereby enhancing processing efficiency. In another embodiment, not shown, all of the tiers comprise a cutting surface formed of polycrystalline CVD diamond as disclosed herein.

In another embodiment, not shown, substantially all of the tool head is coated in polycrystalline CVD diamond. In another embodiment, not shown, only the cutting surface(s) of the tool head is coated in polycrystalline CVD diamond.

In an embodiment, the tool head does not comprise any flutes. In another embodiment, the tool head is substantially free of flutes.

Since a tier configured for roughing produces yet more wear than a tier configured for semi-finishing, the proportion of tiers configured for roughing will be at least double the quantity of tiers configured for semi-finishing, typically three to four times. For example, a single tool configured for all three cutting (e.g. grinding) operations may have nine tiers in total, e.g. six tiers for roughing, two tiers for semi-finishing, and one tier for finishing.

Turning now to FIG. 10, another embodiment of a tool head 28 is shown. In this embodiment, two tiers 18a and 18b are provided, each separated from the adjacent tiers by a non-cutting portion, and the tool head is provided with a notching element 22.

In any of the above embodiments, the tool shank 12 may comprise cemented metal carbide, for example tungsten carbide, although other suitable materials are envisaged, such as silicon carbide and silicon nitride. Optionally, the tool shank 12 comprises a conduit (not shown) for carrying compressed air to the tool head to eject waste cutting media from the cutting surface.

In any of the above embodiments, the tool head 16 may be cylindrical and non-tubular.

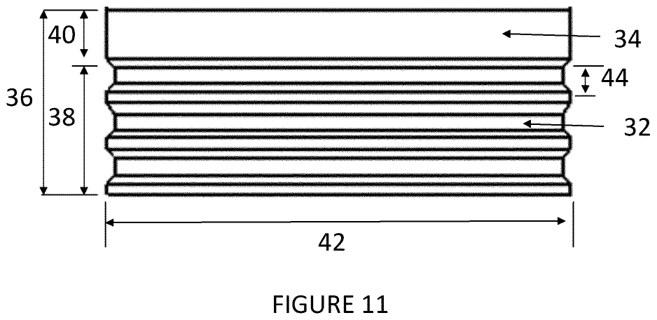

Referring to FIG. 11, an overall height of the tool head 16 is indicated at 36, and it is the sum of the height 38 of the tiered portions 32 and the height 40 of the upper portion 34. Optionally, the height 36 of the tool head 16 is 0.5 mm to 12 mm. Optionally, the height 36 of the tool head 16 is 1 to 10 mm. Optionally, the height 36 of the tool head 16 is 6 mm. The height 38 of the tiered portion 32 may be in the range of 0.5 to 6 mm, for example 2.5 mm. Optionally, the height 36 of the tool head 16 is no more than 12 mm.

The outer diameter of the tool 10 is indicated at 42 and is the largest, outermost, diameter of any of the tiers 18 and the shank 12. Individual tiers 18 may have different diameters to each other, depending, for example on which cutting (e.g. grinding) operation they are configured for. Optionally, all tiers 18 will have the same diameter.

Preferably, the tool 10, 24, 26, 28 has an outer diameter of no more than 15 mm. Optionally, the outer diameter 42 of the tool is 10 mm. In one example of the tool, the overall height of the tool, including tool shank 12 and tool head 16 may be around 200 mm.

The height 44 of each tier 18 (measured axially, the same as the previous height measurements) depends on the quantity of tiers 18 and the height 38 of the substrate. As an example, for a tool head 16 which has a tool head 36 height of 6 mm, the height 38 of the tiered portion is 2.5 mm, and for three tiers, the height 44 of each tier is 0.6 to 0.7 mm.

The aforementioned parameters, i.e. the sharpness ratio β, the average height H (mm) of the satellites (i.e. protrusions), the average overlapping length L (mm) between two adjacent satellites (i.e. protrusions), the average diameter D of the satellites (i.e. protrusions) and the area density C of the satellites (i.e. protrusions), of the cutting surface of the or each tier are optimised depending on whether the aim of the cutting operation is for roughing, semi-finishing or finishing in the context of cutting glass or other similar brittle material. A roughing cutting operation is generally intended to prepare the surface of the workpiece before the finishing operation. The purpose is to bring the dimension to a “rough” size of the final dimension. How this looks may be of little importance since the main aim is to clear away relatively large amounts of material quickly. A semi-finishing cutting operation is typically the next stage after roughing. The purpose is to achieve a dimension even closer to the final dimension. A finishing cutting operation is the final stage of machining a workpiece. A minimal quantity of workpiece material is removed, the workpiece is machined to size, the final dimension is obtained and sometimes the surface is further refined too.

A way to make one of the tool heads described is as follows: a cemented carbide disc blank is provided and a precursor tool head is machined from the disc. A tier is formed in the precursor tool head, for example, using a laser. This step is repeated as required, for example to form a tool head comprising at least two tiers, and wherein the tiers are axially displaced from each other and separated by a non-cutting portion of the tool head. Finally, polycrystalline diamond is deposited on the tool head, for example on the tiers using chemical vapour deposition. Typically, hot filament CVD is used, but other forms of CVD such as microwave plasma CVD may be used. A final finishing operating may be required on the deposited diamond layer on the tool head.

The cutting tool of the present invention may be used in cutting a brittle material. The brittle material may be any of glass, ceramic, polymer, composites, metallic materials and metal-ceramic composites.

In summary, the inventors have devised a cutting tool that maximises tool life and improves the cost/benefit performance. This is done through the use of a tool head comprising a tier with a CVD diamond cutting surface comprising a plurality of satellites (i.e. protrusions) as described herein.

While this invention has been particularly shown and described with reference to embodiments, it will be understood by those skilled in the art that various changes in form and detail may be made without departing from the scope of the invention as defined by the appended claims.

1. A cutting tool comprising:
a tool shank having an axis of rotation, and further comprising a tool head at one end thereof, the tool head comprising a tier,
wherein the tier of the tool head comprises a cutting surface formed of polycrystalline CVD diamond and wherein the cutting surface comprises a plurality of satellites,
wherein a sharpness ratio β of the cutting tool is in a range from about 0.01 to about 1.5,
wherein the sharpness ratio β is the ratio of an average height H (mm) of the satellites to an average overlapping length L (mm) between two adjacent satellites.

2. The cutting tool of claim 1, wherein the average height H (mm) of the satellites is from about 0.005 mm to about 0.025 mm.

3. The cutting tool of claim 1, wherein the average overlapping length L (mm) between two adjacent satellites is from about 0.02 mm to about 1 mm.

4. The cutting tool of claim 1, wherein the satellites have an average diameter D of from about 0.005 mm to about 0.025 mm.

5. The cutting tool of claim 1, wherein an area density C of the satellites is from about 50 per mm² to about 1000 per mm².

6. The cutting tool of claim 1, wherein CD≥1, wherein C is an area density (per mm²) of the satellites and D is an average diameter (mm) of the satellites.

7. The cutting tool of claim 1, wherein the satellites are continuously curved.

8. The cutting tool of claim 1, wherein the tool head comprises at least one further tier, wherein the tiers are axially displaced from each other and separated by a non-cutting portion of the tool head.

9. The cutting tool of claim 8, wherein at least one of the at least one further tiers comprises a cutting surface formed of polycrystalline CVD diamond, wherein the cutting surface comprises a plurality of satellites as defined in claim 1.

10. The cutting tool of claim 8, wherein each tier comprises a cutting surface formed of polycrystalline CVD diamond, wherein the cutting surface comprises a plurality of satellites as defined in claim 1.

11. The cutting tool of claim 8, wherein the tool comprises at least two tiers or at least three tiers.

12. (canceled)

13. (canceled)

14. The cutting tool of claim 8, in which two or more tiers are configured for the same operation.

15. The cutting tool of claim 8, in which each tier is configured differently to the remaining tiers.

16. The cutting tool of claim 8, in which at least one tier has a different diameter to the other tiers.

17. (canceled)

18. The cutting tool of claim 1, in which the tool head has an overall height of no more than 12 mm and/or in which the tool head has an overall height of no less than 0.5 mm.

19. The cutting tool of claim 1, wherein the tool shank has an outer diameter selected from any of no more than 15 mm, no more than 10 mm and no less than 6 mm.

20. The cutting tool of claim 1, in which the tool shank and/or the tool head comprises cemented carbide.

21. A method of making a cutting tool head, the method comprising the steps of:
a. providing a disc blank;
b. machining at least one precursor tool head from the disc;
c. forming a tier in the precursor tool head to thereby form a tool head comprising a tier; and
d. depositing polycrystalline diamond on the tier of the tool head using chemical vapour deposition to form a cutting surface of polycrystalline CVD diamond on the tier, wherein the cutting surface comprises a plurality of satellites, wherein a sharpness ratio β of the cutting tool is in the range from about 0.01 to about 1.5, wherein the sharpness ratio β is the ratio of the average height H (mm) of the satellites to the average overlapping length L (mm) between two adjacent satellites.

22. The method of claim 21, further comprising repeating step c as required, to thereby form a tool head comprising at least two tiers, each tier comprising a cutting surface formed of polycrystalline CVD diamond, wherein the cutting surface comprises a plurality of satellites, wherein the tiers are axially displaced from each other and separated by a non-cutting portion of the tool head.

23. The method of claim 22, wherein the chemical vapour deposition of polycrystalline diamond comprises hot filament chemical vapour deposition.

24. (canceled)

25. (canceled)
